(19) United States
(12) Patent Application Publication
(10) Pub. No.: US 2012/0229726 A1
(43) Pub. Date: Sep. 13, 2012

(54) LIQUID CRYSTAL DISPLAY APPARATUS

(75) Inventor: Sung Ki KIM, Seoul (KR)

(73) Assignee: SAMSUNG ELECTRONICS CO., LTD., Suwon-si (KR)

(21) Appl. No.: 13/412,300

(22) Filed: Mar. 5, 2012

(30) Foreign Application Priority Data
Mar. 10, 2011 (KR) 10-2011-0021420

(51) Int. Cl. G02F 1/13357

(52) U.S. Cl. 349/58

(57) ABSTRACT

Disclosed herein is a liquid crystal display apparatus, which uses a Light Emitting Diode (LED) as a light source of a backlight unit, having an improved structure so as to efficiently cool heat generated by the LED. The liquid crystal display apparatus includes at least one loop heat pipe forming a loop so as to transfer heat generated from LED module to a bottom chassis.

### CROSS-REFERENCE TO RELATED APPLICATION

This application claims the benefit of Korean Patent Application No. 10-2011-0021420 filed on Mar. 10, 2011 in the Korean Intellectual Property Office, the disclosure of which is hereby incorporated herein by reference.

### BACKGROUND

1. Field

Exemplary Embodiments of the inventive concept relate to a liquid crystal display apparatus which uses a Light Emitting Diode (LED) as a light source and enhances the heat radiation efficiency of the LED to improve product reliability.

2. Description of the Related Art

In general, a liquid crystal display apparatus is an electrical apparatus which utilizes variation in a transmittance of a liquid crystal according to an applied voltage in order to change various types of electric information generated from a variety of devices into visual information and to transfer the same. The liquid crystal display apparatus requires a backlight unit due to a lack of a self-luminescent characteristic, thereby using a Cold Cathode Fluorescent Lamp (CCFL), an External Electrode Fluorescent Lamp (EEFL), a Light Emitting Diode (LED), or the like as a light source of the backlight unit. Particularly, LEDs are eco-friendly elements and have a long lifespan, thereby entering into widespread use.

Meanwhile, a heat radiation structure of the backlight unit used to radiate heat generated from the light source is a highly significant portion required to prevent performance deterioration of the backlight unit.

In particular, in the case of a corner type backlight module in which one or a few light sources are placed at a corner of a light guide plate, or an edge type backlight module in which a plurality of light sources are placed in a line at a side surface of the light guide plate, efficient heat radiation of the LED is a first consideration in product design.

### SUMMARY

Therefore, an aspect of the exemplary embodiments is to provide a liquid crystal display apparatus, which uses a Light Emitting Diode (LED) as a light source of a backlight unit, having an improved structure to enable efficient radiation of heat generated by the LED.

Additional aspects of the exemplary embodiments will be set forth in part in the description which follows and, in part, will be obvious from the description, or may be learned by practice of the inventive concept.

In accordance with one aspect of the exemplary embodiments, a liquid crystal display apparatus includes a liquid crystal panel to form an image, a light guide plate to guide light to the liquid crystal panel, at least one LED module including at least one LED package to emit light to the light guide plate and a printed circuit board on which the LED package is mounted, a bottom chassis placed on a back surface of the light guide plate to receive the light guide plate, and at least one loop heat pipe forming a loop so as to transfer heat generated from the LED module to the bottom chassis.

The loop heat pipe may be formed in a vacuum state so that working fluid is injected.

The at least one loop heat pipe may include an evaporating portion coming into contact with the LED module to evaporate the working fluid, a condensing portion coming into contact with the bottom chassis to condense the working fluid, a steam pipe connecting the evaporating portion and the condensing portion so that the working fluid in gas phase is transferred from the evaporating portion to the condensing portion, and a liquid pipe connecting the condensing portion and the evaporating portion so that the working fluid in liquid phase is transferred from the condensing portion to the evaporating portion, the liquid pipe being provided independently of the steam pipe.

The evaporating portion may be formed in a flat shape.

The evaporating portion may include a flat shaped evaporating surface which comes into contact with the LED module, a wick structure installed within the evaporating portion to create capillary force, and a compensatory chamber into which the working fluid is introduced due to the capillary force created by the wick structure.

The loop heat pipe may be installed between the light guide plate and the bottom chassis so that the condensing portion comes into contact with a front surface of the bottom chassis.

The bottom chassis may include a receiving groove portion formed so as to correspond to a shape of the loop heat pipe in order to receive the loop heat pipe.

The loop heat pipe may be installed to form a loop along an edge area of the bottom chassis.

The loop heat pipe may be installed to form a loop progressed in a zigzag form.

The light guide plate may include a corner portion formed in a flat shape, and the LED package may be placed adjacent to the corner portion so as to emit light to the corner portion.

The at least one LED package may be comprised of LED packages placed in a line along a side surface of the light guide plate.

The at least one loop heat pipe may be comprised of a plurality of loop heat pipes, and the at least one LED module may come into contact with evaporating portions of the respective loop heat pipes.

In accordance with another aspect of the exemplary embodiments, a liquid crystal display apparatus includes a liquid crystal panel to form an image, a light guide plate placed on a back surface of the liquid crystal panel to guide light to the liquid crystal panel, the light guide plate having a corner portion formed in a flat shape, an LED package placed adjacent to the corner portion so as to emit light to the corner portion, the LED package including at least one LED chip, a printed circuit board on which the LED package is mounted, a bottom chassis placed on a back surface of the light guide plate to receive the light guide plate, and a loop heat pipe forming a loop so as to transfer heat generated from the LED package to the bottom chassis.

The loop heat pipe may include an evaporating portion having a flat shaped evaporating surface to come into contact with the LED package, a condensing portion coming into contact with the bottom chassis, a steam pipe connecting the evaporating portion and the condensing portion, and a liquid pipe connecting the condensing portion and the evaporating portion while being provided independently of the steam pipe.

The loop heat pipe may be installed to form a loop along an edge area of the bottom chassis.

The loop heat pipe may be installed to pass a central area of the bottom chassis and to form a loop progressed in a zigzag form.

### BRIEF DESCRIPTION OF THE DRAWINGS

These and/or other aspects of the exemplary embodiments will become apparent and more readily appreciated from the following description of the embodiments, taken in conjunction with the accompanying drawings of which:

FIG. 1 is an exploded perspective view illustrating a liquid crystal display apparatus according to an exemplary embodiment;

FIG. 2 is an exploded perspective view illustrating a liquid crystal module of FIG. 1;

FIG. 3 is a sectional view taken along line A-A of FIG. 2;

FIG. 4 is a top view illustrating a light guide plate of FIG. 2;

FIG. 5 is a perspective view illustrating a loop heat pipe of FIG. 2;

FIG. 6 is a sectional view taken along line B-B of FIG. 5;

FIG. 7 is a view illustrating a lower structure of the liquid crystal module shown in FIG. 2;

FIG. 8 is a view illustrating a lower structure of a liquid crystal module according to another exemplary embodiment;

FIG. 9 is a view illustrating a lower structure of a liquid crystal module according to another exemplary embodiment;

FIG. 10 is a view illustrating a lower structure of a liquid crystal module according to another exemplary embodiment;

FIG. 11 is a view illustrating a lower structure of a liquid crystal module according to another exemplary embodiment;

FIG. 12 is a view illustrating a lower structure of a liquid crystal module according to another exemplary embodiment;

FIG. 13 is a view illustrating a lower structure of a liquid crystal module according to another exemplary embodiment; and

FIG. 14 is a view illustrating a lower structure of a liquid crystal module according to another exemplary embodiment.

### DETAILED DESCRIPTION

Reference will now be made in detail to the exemplary embodiments, which are illustrated in the accompanying drawings, wherein like reference numerals refer to like elements throughout.

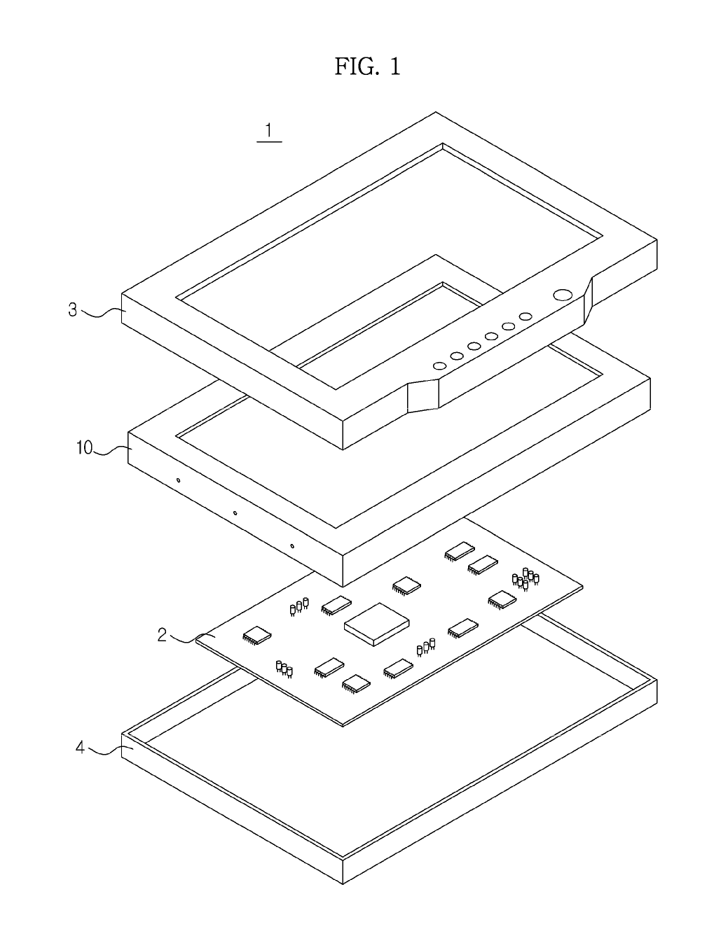

FIG. 1 is an exploded perspective view illustrating a liquid crystal display apparatus according to an exemplary embodiment.

Referring to FIG. 1, the liquid crystal display apparatus, which is designated by reference numeral 1, includes a front cover 3, a liquid crystal module 10, a main board 2, and a rear cover 4.

The main board 2 applies a signal to the liquid crystal module 10 to operate the liquid crystal module 10. The front and rear covers 3 and 4 are placed at front and rear sides (upper and lower sides as illustrated in the drawing) of the liquid crystal module 10 and main board 2 so as to cover and support the liquid crystal module 10 and the main board 2, respectively.

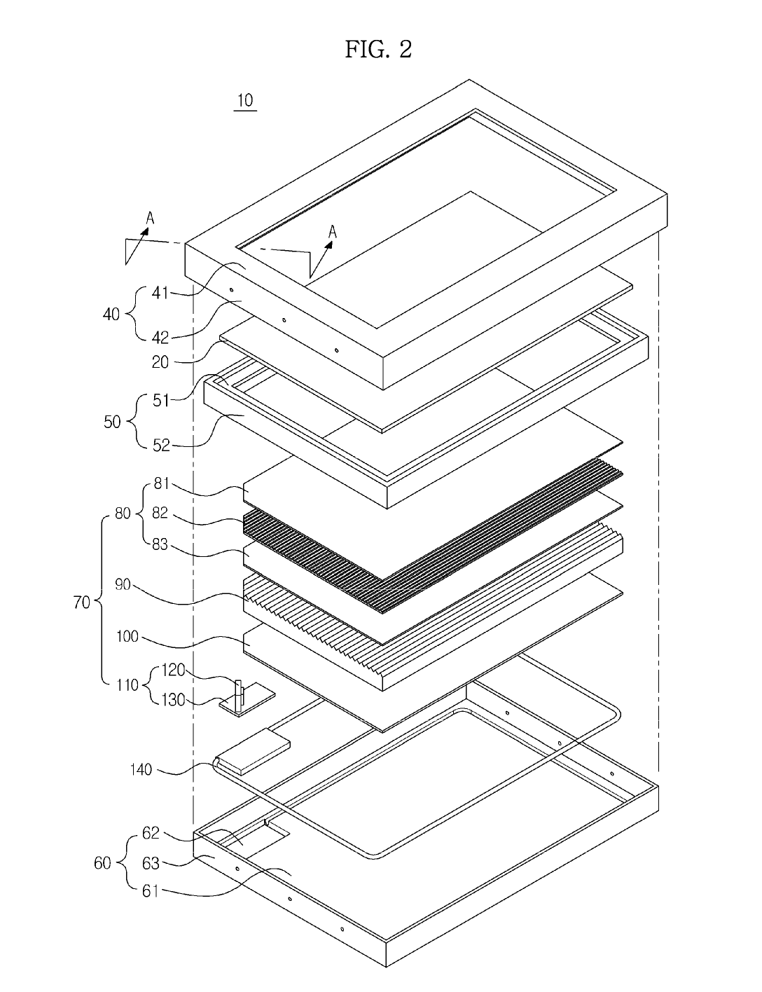

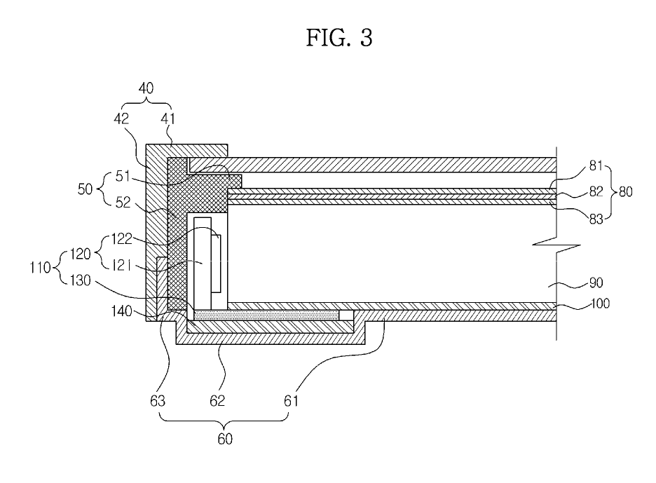

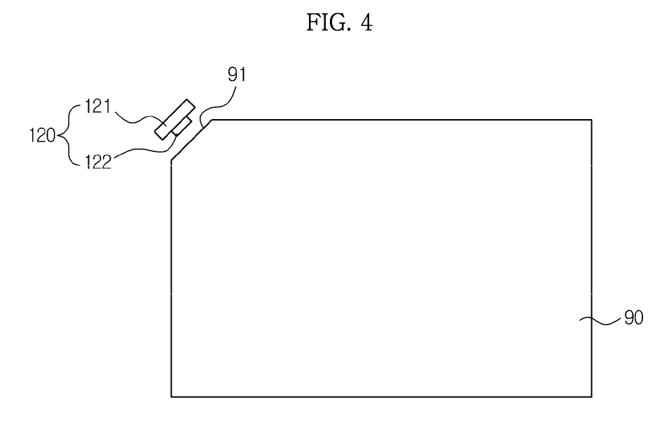

FIG. 2 is an exploded perspective view illustrating the liquid crystal module of FIG. 1. FIG. 3 is a sectional view taken along line A-A of FIG. 2. FIG. 4 is a top view illustrating a light guide plate of FIG. 2.

Referring to FIGS. 2 to 4, the liquid crystal module 10 includes a top chassis 40, a liquid crystal panel 20, a middle mold 50, a backlight unit 70, a loop heat pipe 140, and a bottom chassis 60.

The liquid crystal panel 20 corresponds to a display portion of the liquid crystal module 10 to form an image. Although not shown, the liquid crystal panel 20 may include two sheets of thin glass substrates, liquid crystal received therebetween, and a transparent electrode provided so as to apply voltage to the liquid crystal.

The backlight unit 70 is placed on a back surface of the liquid crystal panel 20 so as to emit light to the liquid crystal panel 20. The backlight unit 70 includes an optical sheet 80, a light guide plate 90, a reflection sheet 100, and a light emitting diode (LED) module 110.

The light guide plate 90 may be made of an acrylic resin. Also, the light guide plate 90 has a substantially hexahedral shape while being formed, at one corner portion 91 thereof, as a flat shape. The light guide plate 90 may be formed, on a back surface thereof, with a variety of patterns in order to break total reflection of light which is incident onto the corner portion of the light guide plate 90 and to evenly emit the light to a front surface (an upper surface as illustrated in the drawing) of the light guide plate 90.

The reflection sheet 100 is placed on the back surface of the light guide plate 90 so that the light directed downwards by total reflection from the light guide plate 90 is reflected again to the light guide plate 90.

The optical sheet 80 includes a protective sheet 81, a prism sheet 82, and a diffusion sheet 83.

The diffusion sheet 83 is provided on the front surface of the light guide plate 90 so that the light emitted from the front surface of the light guide plate 90 is diffused and supplied to the liquid crystal panel 20. The diffusion sheet 83 may be formed with a coating layer having a bead shape so as to diffuse light. The prism sheet 82 concentrates the light diffused from the diffusion sheet 83 in a direction perpendicular to a plane of the liquid crystal panel 20. The protective sheet 81 is provided on a front surface (an upper surface as illustrated in the drawing) of the prism sheet 82 to protect the prism sheet 82 which is sensitive to scratches from dust and so on.

The LED module 110 includes an LED package 120 to emit light and a printed circuit board 130 mounted, on an upper surface thereof, with the LED package 120 so as to drive the LED package 120 through supply of an external power source.

The LED package 120 includes a package body 121 having at least one LED chip and a light emitting surface 122 formed at one surface of the package body 121 so as to emit light. The LED package 120 is electrically connected with the printed circuit board 130 so that power is supplied.

Meanwhile, although a side view type LED package is used as the LED package 120 in the present exemplary embodiment so that a bezel portion 41 of the top chassis 40 is thin in width and efficiency of light which is incident onto the light guide plate 90 is increased, the present exemplary embodiment is not limited thereto and a top view type LED package may also be used.

The printed circuit board 130 is connected with the external power source to supply the mounted LED package 120 with power. The printed circuit board 130 is formed as a thin type printed circuit board which is made of a metal material having high heat conductivity to readily conduct heat generated from the LED package 120.

Meanwhile, the top chassis 40, the middle mold 50, and the bottom chassis 60 accommodate and support the liquid crystal panel 20, the backlight unit 70, and the loop heat pipe 140 described below, respectively.

The top chassis 40 includes a bezel portion 41 defining an edge of the liquid crystal module 10 and an upper side wall 42.

The bottom chassis 60 includes a bottom portion 61 formed in a flat shape, a receiving groove portion 62 provided to receive the loop heat pipe 140 described below, and a lower side wall 63 bent upwards from the bottom portion 61.

The receiving groove portion 62 is a groove recessed in the bottom portion 61 so as to correspond to a shape of the loop heat pipe 140. Since the loop heat pipe 140 having a substantially cylindrical shape is tightly received in the receiving groove portion 62, a contact area between the loop heat pipe 140 and the bottom chassis 60 may be widened.

The bottom chassis 60 may be made of a metal material such as aluminum having high heat conductivity so that heat generated from the LED module 110 is readily conducted through the loop heat pipe 140.

The middle mold 50 includes a middle side wall 52 and a support portion 51.

The middle side wall 52 is vertically arranged so that the middle side wall 52 is adhered, at an upper side thereof, to the bezel portion 41 of the top chassis 40 while being adhered, at a lower side thereof, to the printed circuit board 130 of the LED module 110.

The support portion 51 is placed between the liquid crystal panel 20 and the optical sheet 80 so as to allow the liquid crystal panel 20 to be spaced apart from the optical sheet 80 by a predetermined clearance. The support portion 51 is adhered, at a front side (an upper side as illustrated in the drawing) thereof, to the liquid crystal panel 20 while being adhered, at a rear side (a lower side as illustrated in the drawing) thereof, to the optical sheet 80, thereby serving to securely support the liquid crystal panel 20 and the optical sheet 80.

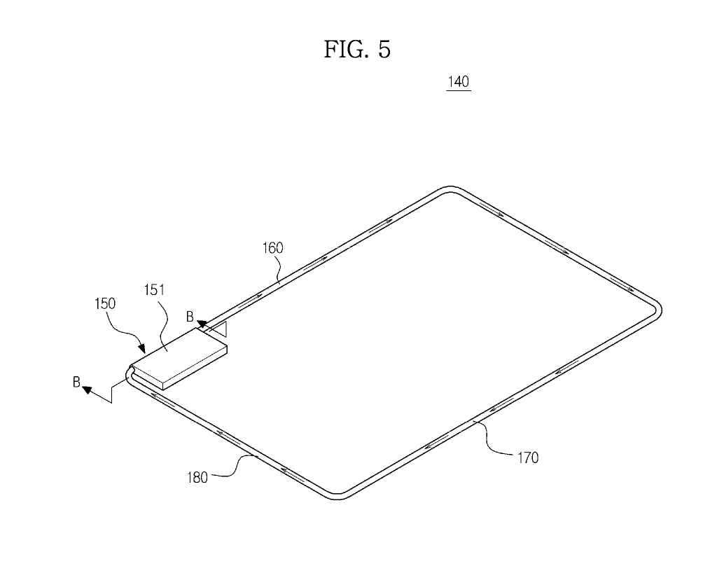

The loop heat pipe 140 is vacuum-formed so that a suitable amount of working fluid is injected into an alloy pipe made of copper, titanium, or the like and the working fluid easily evaporates at a lower temperature. Examples of the working fluid may include water, Freon refrigerant, ammonia, acetone, methanol, and so on. Unlike a general heat pipe, the loop heat pipe 140 forms a loop in which a start point and an end point are connected to each other. Although described below, an evaporating surface 151 (see FIG. 5) of an evaporating portion 150 (see FIG. 5) in the loop heat pipe 140 is placed to come into contact with a back surface of the printed circuit board 130.

FIG. 5 is a perspective view illustrating the loop heat pipe of FIG. 2.

Referring to FIG. 5, the loop heat pipe 140 includes an evaporating portion 150 which absorbs heat from an external heat source to evaporate the working fluid, a condensing portion 170 which radiates the heat to the outside to condense the working fluid, a steam pipe 160 to transfer the working fluid in gas phase from the evaporating portion 150 to the condensing portion 170, and a liquid pipe 180 to transfer the working fluid in liquid phase from the condensing portion 170 to the evaporating portion 150.

Here, the steam pipe 160 and the liquid pipe 180 are separately provided so that the loop heat pipe 140 is formed as one loop, and the working fluid flows within the loop heat pipe 140 in one direction only.

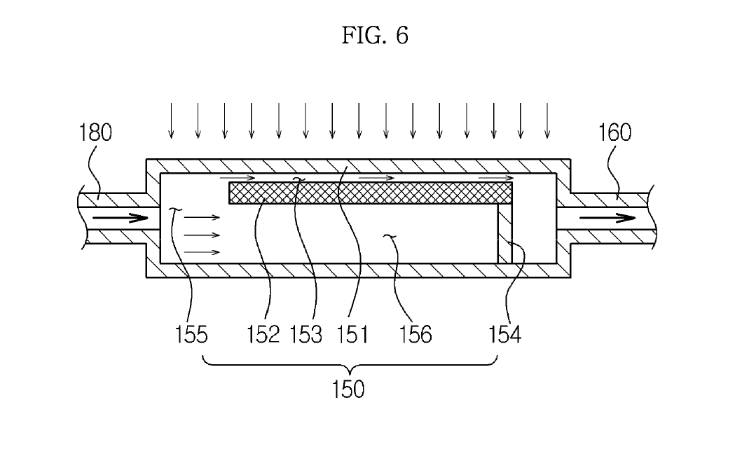

The evaporating portion 150 is installed therein with a wick structure 152 (see FIG. 6) which is a capillary structure. The wick structure 152 may be formed in a net shape and be made of a thin metal. In the loop heat pipe 140, the wick structure 152 is installed only within the evaporating portion 150 without being installed in the steam pipe 160, the condensing portion 170, and the liquid pipe 180. Accordingly, the loop heat pipe 140, unlike the general heat pipe, may be formed to be freely bent.

FIG. 6 is a sectional view taken along line B-B of FIG. 5.

Referring to FIG. 6, the evaporating portion 150 is connected, at one side thereof, with the liquid pipe 180 so that the working fluid in liquid phase is transferred into the evaporating portion 150, while being connected, at the other side thereof, with the steam pipe 160 so that the working fluid in gas phase is transferred from the evaporating portion 150.

The evaporating surface 151 is one surface defining an external appearance of the evaporating portion 150 and is formed in a flat shape to easily come into contact with the external heat source. The wick structure 152 generates capillary force and is installed within the evaporating portion 150 along a longitudinal direction of the evaporating surface 151.

In addition, the evaporating portion 150 is mounted therein with a cutoff wall 154 to fix the wick structure 152 and form a liquid phase chamber 156 by blocking flow of the working fluid in liquid phase. The evaporating portion 150 is formed, at an inlet thereof, with a compensatory chamber 155 so that the condensed working fluid is supplied through the liquid pipe 180.

In accordance with the structure as described above, the working fluid in liquid phase is introduced into the compensatory chamber 155 and then passes the liquid phase chamber 156 and the wick structure 152 in turn. The working fluid in liquid phase evaporates by the external heat source during this course. The evaporated working fluid in gas phase is transferred to the steam pipe 160 through a gas phase channel 153 to be continuously circulated throughout the loop heat pipe 140.

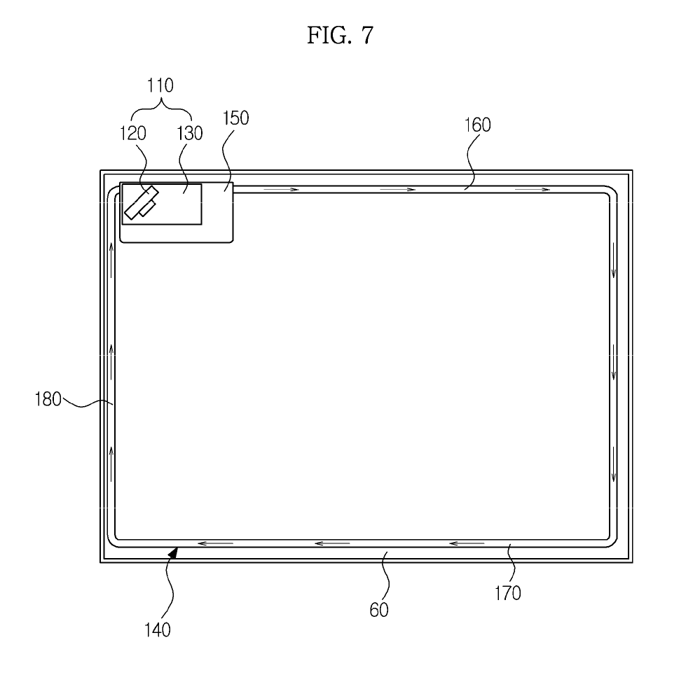

FIG. 7 is a view illustrating a lower structure of the liquid crystal module shown in FIG. 2.

Referring to FIG. 7, the loop heat pipe 140 forms the loop so that the working fluid passes through the evaporating portion 150, the steam pipe 160, the condensing portion 170, and the liquid pipe 180 in turn and is circulated in the loop heat pipe 140. The LED module 110, which is composed of the LED package 120 to emit light and the printed circuit board 130, is placed at a corner side of the bottom chassis 60.

The evaporating portion 150 of the loop heat pipe 140 comes into contact with the printed circuit board 130 to absorb heat from the LED package 120, and the condensing portion 170 comes into contact with a front surface (an upper surface as illustrated in the drawing) of the bottom chassis 60.

In this case, the loop heat pipe 140 forms the loop along an edge of the bottom chassis 60. Although the loop heat pipe 140 is relatively freely bent as described above, the loop heat pipe 140, when arranged to largely form the loop along the edge of the bottom chassis 60, may be easily processed and have a simplified structure. As a result, a broad range of product designs may be achieved.

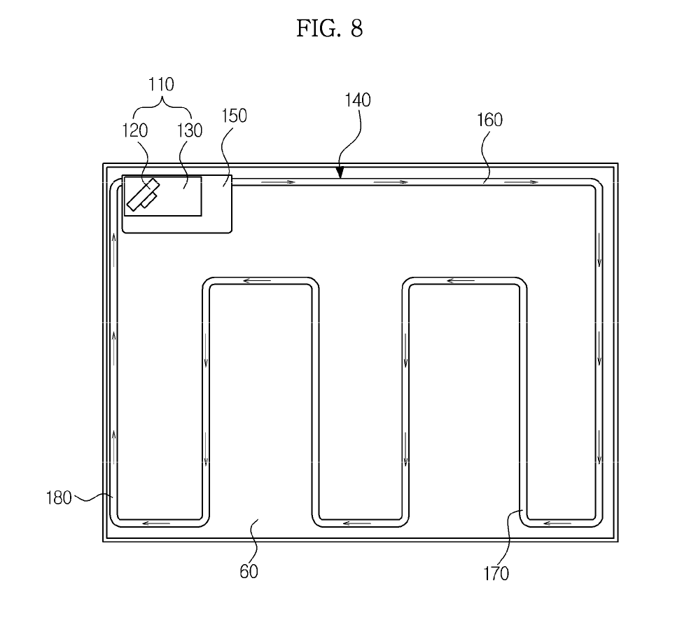

FIG. 8 is a view illustrating a lower structure of a liquid crystal module according to another exemplary embodiment. The liquid crystal module according to the present exemplary embodiment is similar to the configuration of the embodiment illustrated in FIG. 7, but differs in that a loop shape of a loop heat pipe 140 is deformed. Hereinafter, like reference numerals will refer to like elements and no description will be given thereof in another exemplary embodiment.

Referring to FIG. 8, the loop heat pipe 140 forms a loop progressed to be bent in a zigzag form. The loop heat pipe 140 forms the loop so as to come into contact with the greater part of the bottom chassis 60 including a central portion thereof.

Although the loop heat pipe 140 according to the present exemplary embodiment has a longer overall length and a bent region thereof is increased, compared with the embodiment illustrated in FIG. 7, the temperature of the bottom chassis 60 may be uniform, thereby enhancing heat radiation efficiency.

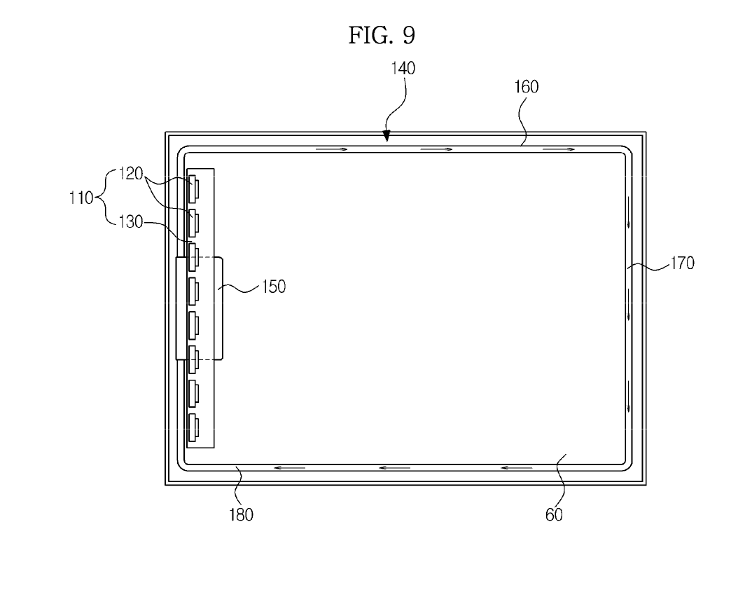

FIG. 9 is a view illustrating a lower structure of a liquid crystal module according to another exemplary embodiment.

Referring to FIG. 9, the liquid crystal module according to the present exemplary embodiment includes an LED module 110 placed at one side of the light guide plate. A plurality of LED packages 120 are mounted on a printed circuit board 130 so as to be placed in a line along a side surface of the light guide plate while being spaced apart from one another by a predetermined distance. The printed circuit board 130 is formed to a length sufficient to be mounted with the plural LED packages 120.

The plural LED packages 120 are used in the present exemplary embodiment contrary to the embodiment illustrated in FIG. 7. Since low luminance LED packages 120 are used as compared with the embodiment illustrated in FIG. 7, the backlight unit may be configured at the same luminance as the embodiment illustrated in FIG. 7. In this case, heat radiation may be naturally achieved using a loop heat pipe 140.

The loop heat pipe 140 may be arranged so that an evaporating portion 150 comes into contact with a central portion of the printed circuit board 130 on which the plural LED packages 120 are mounted.

A heat radiation structure of the loop heat pipe 140 is the same as the embodiments illustrated in FIGS. 7 and 8. That is, the working fluid evaporates at the evaporating portion 150, the working fluid in gas phase is condensed at the condensing portion 170 via the steam pipe 160, and the condensed working fluid in liquid phase again flows to the evaporating portion 150 via the liquid pipe 180 so that heat of the LED module 110 is transferred to the bottom chassis 60 and is radiated thereby.

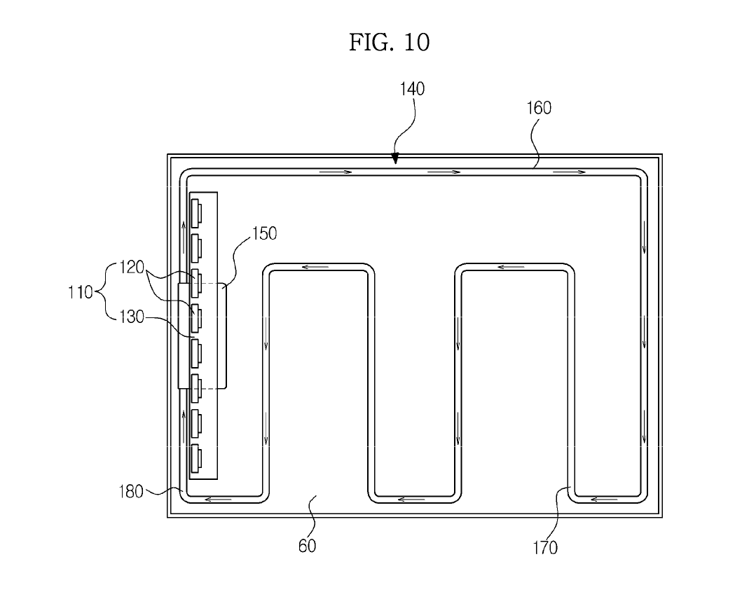

FIG. 10 is a view illustrating a lower structure of a liquid crystal module according to another exemplary embodiment.

Referring to FIG. 10, the liquid crystal module according to the present exemplary embodiment is similar to the configuration of the embodiment illustrated in FIG. 9, but differs in that a loop shape of a loop heat pipe 140 is deformed. The loop heat pipe 140 forms a loop progressed to be bent in a zigzag form so as to come into contact with the greater part of the bottom chassis 60 including a central portion thereof. Due to this structure, the temperature of the bottom chassis 60 may be uniform to enhance heat radiation efficiency, as described above.

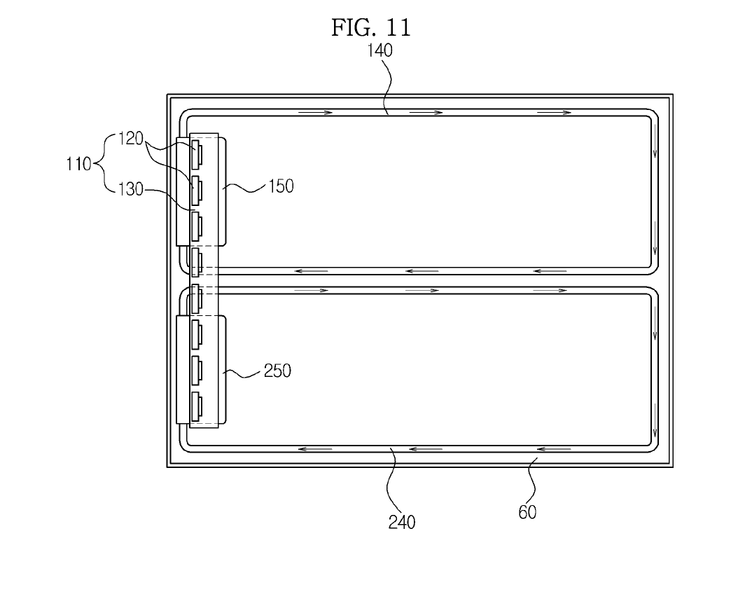

FIG. 11 is a view illustrating a lower structure of a liquid crystal module according to another exemplary embodiment.

Referring to FIG. 11, the liquid crystal module according to the present exemplary embodiment includes an LED module 110 placed at one side of the light guide plate and two loop heat pipes 140 and 240 which respectively form loops to radiate heat of the LED module 110.

A plurality of LED packages 120 is mounted in a line on a printed circuit board 130 to be spaced apart from one another by a predetermined clearance.

The printed circuit board 130 comes, at a back surface thereof, into contact with evaporating portions 150 and 250 of the respective loop heat pipes 140 and 240 so that heat is rapidly radiated from the printed circuit board 130. The working fluid is circulated in each of the loop heat pipes 140 and 240 so as to radiate heat.

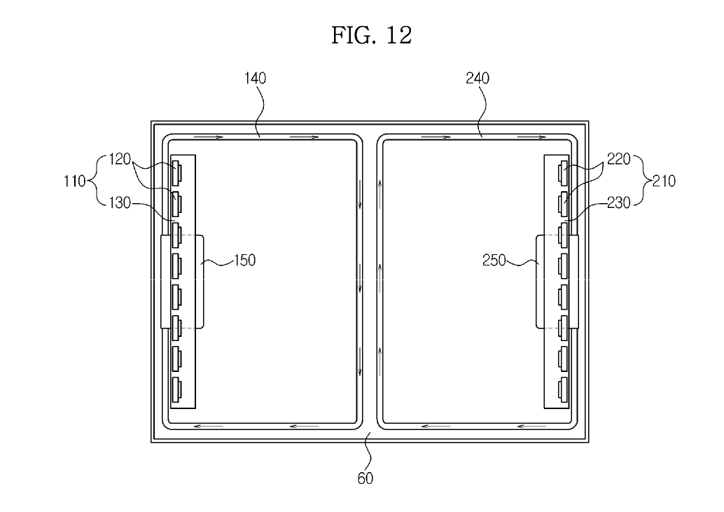

FIG. 12 is a view illustrating a lower structure of a liquid crystal module according to another exemplary embodiment.

Referring to FIG. 12, the liquid crystal module includes two LED modules 110 and 210 placed at opposite sides of the light guide plate, respectively. Also, the liquid crystal module includes two loop heat pipes 140 and 240 to radiate heat of the LED modules 110 and 210, respectively.

The LED module 110 of the modules includes a plurality of LED packages 120 and a printed circuit board 130 on which the plural LED packages 120 are mounted to be placed in a line and be spaced apart from one another by a predetermined clearance. Similarly, the LED module 210 facing the LED module 110 includes a plurality of LED packages 220 and a printed circuit board 230 on which the plural LED packages 220 are mounted to be placed in a line and be spaced apart from one another by a predetermined clearance.

The loop heat pipe 140 may be arranged so that an evaporating portion 150 comes into contact with a central portion of the printed circuit board 130, whereas the loop heat pipe 240 may be arranged so that an evaporating portion 250 comes into contact with a central portion of the printed circuit board 230.

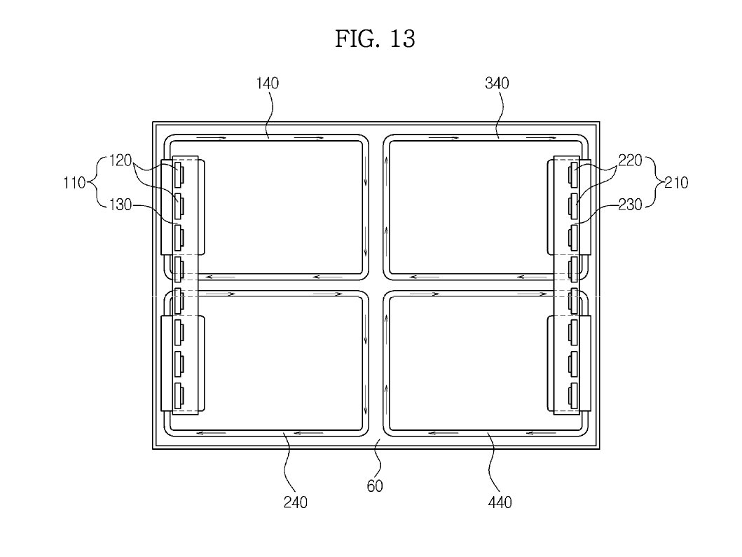

FIG. 13 is a view illustrating a lower structure of a liquid crystal module according to another exemplary embodiment.

Referring to FIG. 13, the liquid crystal module includes two LED modules 110 and 210 placed at opposite sides of the light guide plate, respectively. Also, the liquid crystal module includes four loop heat pipes 140, 240, 340, and 440 to radiate heat of the LED modules 110 and 210.

Here, the two loop heat pipes 140 and 240 serve to radiate heat of the LED module 110, whereas the two loop heat pipes 340 and 440 serve to radiate heat of the LED module 210.

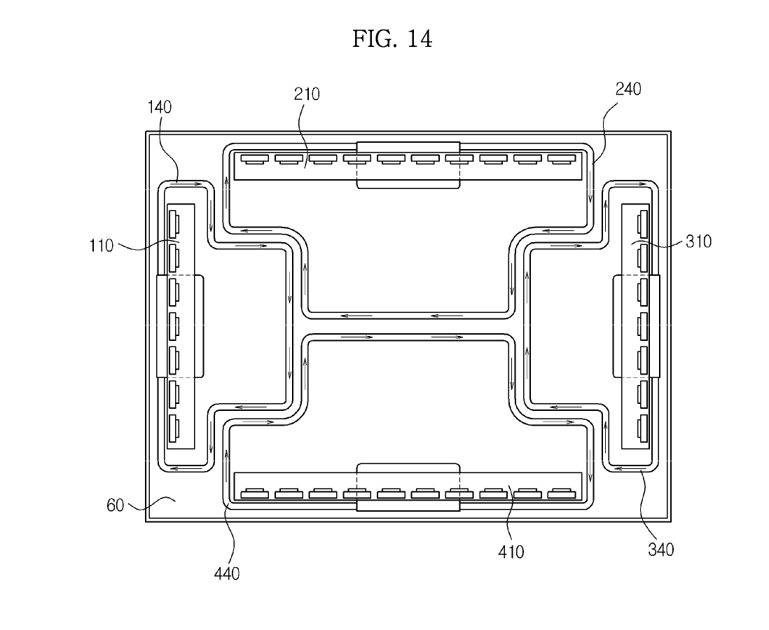

FIG. 14 is a view illustrating a lower structure of a liquid crystal module according to another exemplary embodiment.

Referring to FIG. 14, the liquid crystal module includes four LED modules 110, 210, 310, and 410 placed adjacent to four side surfaces of the light guide plate, respectively. Also, the liquid crystal module includes four loop heat pipes 140, 240, 340, and 440 to radiate heat of the LED modules 110, 210, 310, and 410, respectively.

As is apparent from the above description, since the loop heat pipe forming the loop allows heat generated from the LED to be effectively transferred to the bottom chassis, heat radiation of the LED may be sufficiently achieved, thereby improving reliability of the liquid crystal display apparatus.

In particular, heat radiation for high luminance LEDs may be sufficiently achieved, thereby decreasing the number of LEDs required for the backlight unit to attain cost reduction. As a result, a broad range of product designs may be increased.

Although a few exemplary embodiments of the inventive concept have been shown and described, it would be appreciated by those skilled in the art that changes may be made in these embodiments without departing from the principles and spirit of the inventive concept, the scope of which is defined in the claims and their equivalents.

What is claimed is:

1. A liquid crystal display apparatus comprising:
a liquid crystal panel which forms an image;
a light guide plate which guides light to the liquid crystal panel;
at least one LED module including at least one LED package which emits light to the light guide plate and a printed circuit board on which the LED package is mounted;
a bottom chassis placed on a back surface of the light guide plate which receives the light guide plate; and
at least one loop heat pipe forming a loop which transfers heat generated from the LED module to the bottom chassis.

2. The liquid crystal display apparatus according to claim 1, wherein the loop heat pipe is formed in a vacuum state so that working fluid is disposed therein.

3. The liquid crystal display apparatus according to claim 2, wherein the at least one loop heat pipe comprises:
an evaporating portion coming into contact with the LED module which evaporates the working fluid;
a condensing portion coming into contact with the bottom chassis which condenses the working fluid;
a steam pipe connecting the evaporating portion and the condensing portion in which the working fluid in gas phase is transferred from the evaporating portion to the condensing portion; and
a liquid pipe connecting the condensing portion and the evaporating portion in which the working fluid in liquid phase is transferred from the condensing portion to the evaporating portion, the liquid pipe being provided independently of the steam pipe.

4. The liquid crystal display apparatus according to claim 3, wherein the evaporating portion is formed in a flat shape.

5. The liquid crystal display apparatus according to claim 3, wherein the evaporating portion comprises:
a flat shaped evaporating surface which comes into contact with the LED module;
a wick structure disposed within the evaporating portion which creates capillary force; and
a compensatory chamber into which the working fluid is introduced due to the capillary force created by the wick structure.

6. The liquid crystal display apparatus according to claim 3, wherein the loop heat pipe is disposed between the light guide plate and the bottom chassis so that the condensing portion comes into contact with a front surface of the bottom chassis.

7. The liquid crystal display apparatus according to claim 1, wherein the bottom chassis includes a receiving groove portion formed which corresponds to a shape of the loop heat pipe in order to receive the loop heat pipe.

8. The liquid crystal display apparatus according to claim 1, wherein the loop heat pipe forms a loop along an edge area of the bottom chassis.

9. The liquid crystal display apparatus according to claim 1, wherein the loop heat pipe forms a loop progressed in a zigzag form.

10. The liquid crystal display apparatus according to claim 1, wherein:
the light guide plate includes a corner portion formed in a flat shape; and
the LED package is placed adjacent to the corner portion and emits light to the corner portion.

11. The liquid crystal display apparatus according to claim 1, wherein the at least one LED package is comprised of LED packages placed in a line along a side surface of the light guide plate.

12. The liquid crystal display apparatus according to claim 3, wherein the at least one loop heat pipe is comprised of a plurality of loop heat pipes, and the at least one LED module comes into contact with evaporating portions of the respective loop heat pipes.

13. A liquid crystal display apparatus comprising:
a liquid crystal panel which forms an image;
a light guide plate placed on a back surface of the liquid crystal panel which guides light to the liquid crystal panel, the light guide plate having a corner portion formed in a flat shape;
an LED package placed adjacent to the corner portion which emits light to the corner portion, the LED package including at least one LED chip;
a printed circuit board on which the LED package is mounted;
a bottom chassis placed on a back surface of the light guide plate which receives the light guide plate; and
a loop heat pipe forming a loop which transfers heat generated from the LED package to the bottom chassis.

14. The liquid crystal display apparatus according to claim 13, wherein the loop heat pipe comprises:
an evaporating portion having a flat shaped evaporating surface which comes into contact with the LED package;
a condensing portion which comes into contact with the bottom chassis;
a steam pipe which connects the evaporating portion and the condensing portion; and
a liquid pipe which connects the condensing portion and the evaporating portion while being provided independently of the steam pipe.

15. The liquid crystal display apparatus according to claim 13, wherein the loop heat pipe forms a loop along an edge area of the bottom chassis.

16. The liquid crystal display apparatus according to claim 13, wherein the loop heat pipe forms a loop progressed in a zigzag form.

17. A liquid crystal display apparatus comprising:
at least one LED module comprising at least one LED package which emits light;
a bottom chassis; and
at least one heat pipe which forms a loop which transfers heat generated from the LED module to the bottom chassis.
